(19) United States
(12) Patent Application Publication
(10) Pub. No.: US 2025/0018778 A1
(43) Pub. Date: Jan. 16, 2025

(54) Embedded car cover

(71) Applicant: ZHEJIANG SURPASS AUTO PARTS CO.,LTD., Wenzhou City (CN)

(72) Inventors: Shiqi Zheng, Wenzhou City (CN); Dongdong Wang, Wenzhou City (CN); Yien Wang, Wenzhou City (CN); Yi Lin, Wenzhou City (CN); Lei Lin, Wenzhou City (CN)

(21) Appl. No.: 18/662,638

(22) Filed: May 13, 2024

(30) Foreign Application Priority Data
Jul. 13, 2023 (CN) 202310864988.5

(51) Int. Cl. B60J 7/14; B60J 7/19; B60J 10/90

(52) U.S. Cl. CPC B60J 7/141; B60J 7/198; B60J 10/90

(57) ABSTRACT

The present invention discloses a car cover with rotating shaft hinges, including a large front bar, a rear bar, a guide rail and a plurality of rotating shafts, the guide rail is connected to the car body, the large front bar, the rear bar and the plurality of rotating shafts are all connected to the guide rail, at least one of the rotating shafts is connected to a rotating shaft hinge, the rotating shaft includes a first rotating shaft, a second rotating shaft and a third rotating shaft. The car cover in this invention may includes a plurality of rotating shaft structures or only one rotating shaft structure, the rotating shafts are connected at the rotating shaft by a rotating shaft hinge, which makes the rotating shaft a longer service life.

### CROSS REFERENCE TO RELATED APPLICATION

This application claims priority benefit of Chinese patent Application No. 202310864988. 5, filed on Jul. 13, 2023, and the entire contents of which are incorporated herein by reference.

### TECHNICAL FIELD

This invention is relevant to automotive spare parts, especially a car cover with rotating shaft hinges

### BACKGROUND TECHNOLOGY

The pick-up truck (also known as a sedan truck) is used for carrying goods. Since the pick-up truck's cargo hopper is open, a cover was invented to prevent the goods inside the cargo hopper from getting wet in the rain and snow, by installing the cover on the pick-up truck's cargo hopper and using it to cover the goods inside the hopper.

In order to facilitate the opening of the hood, it is usually necessary to install a rotating structure, as the rotating structure needs to be rotated frequently, this part is vulnerable to damage.

### ABOUT THE INVENTION

The purpose of the present invention is to solve the problem that the rotating structure of the existing car cover is vulnerable to damage, by proposing a car cover with rotating shaft hinges.

In order to solve the above problems of the existing technology, the technical solution adopted in the invention is as follows:

A car cover with rotating shaft hinges including a large front bar, a rear bar, a guide rail and a plurality of rotating shafts.

The guide rail is connected to the car body, the large front bar, the rear bar and the plurality of rotating shafts are connected to the guide rail, at least one of the rotating shafts is connected to a rotating shaft hinge, the rotating shaft hinge is an integrated elongate structure or a plurality of block structures, the rotating shaft includes a first rotating shaft, a second rotating shaft and a third rotating shaft.

The car cover may include a variety of rotating shaft structures or only one, with the rotating shafts being connected at the rotating shafts by a rotating shaft hinge, which makes a longer service life of the rotating shaft.

A car cover with rotating shaft hinges, includes a large front bar, a rear bar, a guide rail and a plurality of rotating shafts.

The guide rail is connected to the car body, the large front bar, the rear bar and the rotating shafts are all connected to the guide rail.

The rotating shaft includes an intermediate rotating shaft and two side rods, the intermediate rotating shaft is rotationally connected to the side rods, both the intermediate rotating shaft and the side rods are provided with a rotating shaft groove, a rubber strip is connected between the intermediate rotating shaft and the side rods, the rubber strip includes a waterproof surface and two mounting feet, both of which are connected to the waterproof surface, the two mounting feet are respectively stuck into the two rotating shaft grooves, one end of the rubber strip is provided with a steel wire rod, the other end of the rubber strip is connected by glue, the steel wire rod is provided inside the rotating shaft groove.

Two side rods are respectively connected to a plate, an intermediate rotating shaft is rotationally connected to the two side rods, so as to achieve the relative rotation of the plates and drive the cover to flip and fold, by setting up a rubber strip at the rotation to carry out waterproofing treatment and avoid water leakage of the car cover, one end of the rubber strip is connected to the side rod or the intermediate rotating shaft by glue, the other side of the rubber strip is connected to the side rod or the intermediate rotating shaft by plugging the steel wire rod, which makes the mounting feet tightly clamped with the rotating shaft groove to achieve a better waterproofing effect, since it is difficult to plug the rubber strips at both ends at the same time, one side is waterproofed by plugging the rubber strips and the other side is waterproofed by gluing.

A car cover with rotating shaft hinges includes a large front bar, a rear bar, a guide rail and a plurality of rotating shafts, the guide rail is connected to the car body, the large front bar, the rear bar and the rotating shafts are all connected to the guide rail.

The rotating shafts and the rear bar are connected to at least one rotating shaft locking bolt system, the rotating shaft locking bolt system includes a guide rail locking bolt clamp and a rotating shaft locking bolt.

The guide rail locking bolt clamp is connected to the guide rail, the guide rail locking bolt clamp includes a guide rail latch, the guide rail locking bolt is provided with a guide rail locking bolt arc surface and a guide rail locking bolt plane, the guide rail locking bolt arc surface is located on the upper side of the guide rail locking bolt plane.

The rotating shaft locking bolt is provided in correspondence with the guide rail latch, the rotating shaft locking bolt is connected to a rotating shaft or a rear bar, the rotating shaft locking bolt includes a rotating shaft locking bolt plane and a rotating shaft locking bolt arc surface, the rotating shaft locking bolt arc surface is provided on the lower side of the rotating shaft locking bolt plane.

Further, the rotating shaft hinge includes a first rotating shaft hinge, the first rotating shaft hinge includes a first hinge base, a second hinge base, a first crank handle, a second crank handle, a first profile and a second profile, both the first hinge base and the second hinge base are provided with a bottom hole and a hinge connecting hole, the first hinge base is connected to the first profile through the bottom hole, the second hinge base connects to the second profile through the bottom hole, both the first crank handle and the second crank handle are provided with a crank connecting hole, the rotating shaft passes through the crank connecting hole and the hinge connecting hole.

Further, the third rotating shaft includes a third rotating shaft left rod, a third rotating shaft right rod, a third rotating shaft intermediate rubber strip, a first left joint of the third rotating shaft, a second left joint of the third rotating shaft, a third rotating shaft hinge, a third rotating shaft hinge positioning block, a first right joint of the third rotating shaft and a second right joint of the third rotating shaft.

The first left joint of the third rotating shaft and the second left joint of the third rotating shaft are provided on the left side of the third rotating shaft, the first right joint of the third rotating shaft and the second right joint of the third rotating shaft are provided on the right side of the third rotating shaft, the third rotating shaft left rod is provided with a third rotating shaft left rod groove, the third rotating shaft right rod is provided with a third rotating shaft right rod groove, the third rotating shaft hinge includes a third rotating shaft hinge bottom, both ends of the third rotating shaft hinge bottom are provided with a third rotating shaft hinge arm and a third rotating shaft hinge cylinder, the two third rotating shaft hinge cylinders are respectively snapped into the third rotating shaft left rod groove and the third rotating shaft right rod groove.

Further, the rubber strip is provided with a rubber strip lower plane, the intermediate rotating shaft is provided with an intermediate rotating shaft plane, the rubber strip lower plane and the intermediate rotating shaft plane are bonded by glue.

Further, the third rotating shaft includes a plurality of third rotating shaft hinge positioning blocks, the third rotating shaft hinge is connected to the third rotating shaft left rod or the third rotating shaft right rod through a plurality of third rotating shaft hinge positioning blocks, the third rotating shaft positioning block is provided with a third rotating shaft positioning block fixing hole and a third rotating shaft fixing block mounting and positioning edge, the third rotating shaft positioning block is connected to the third rotating shaft left rod or the third rotating shaft right rod through the third rotating shaft positioning block fixing hole, the third rotating shaft positioning block is provided for mounting and positioning the third rotating shaft positioning block,

The first left joint of the third rotating shaft, the second left joint of the third rotating shaft, the first right joint of the third rotating shaft and the second right joint of the third rotating shaft are all provided with a cylindrical plug, the cylindrical plug is connected with either the third rotating shaft left rod groove or the third rotating shaft right rod groove, when connecting, insert the cylindrical plug of the first left joint of the third rotating shaft and the cylindrical plug of the first right joint of the third rotating shaft into the third rotating shaft right rod groove, making the first left joint of the third rotating shaft, the first right joint of the third rotating shaft connected to the third rotating shaft right rod, insert the cylindrical plug of the second left joint of the third rotating shaft and the cylindrical plug of the second left joint of the third rotating shaft into the third rotating shaft left rod groove, making the second left joint of the third rotating shaft, the second right joint of the third rotating shaft connected to the left rod of the third rotating shaft, so as to make the first left joint of the third rotating shaft, the second left joint of the third rotating shaft, the first right joint of the third rotating shaft and the second right joint of the third rotating shaft connected with the third rotating shaft left rod groove or the third rotating shaft right rod groove.

The first left joint of the third rotating shaft is provided with a first left joint mounting hole of the third rotating shaft, the second left joint of the third rotating shaft is provided with a second left joint mounting hole of the third rotating shaft.

The third rotating shaft left rod is provided with a third rotating shaft left rod fixing hole, the third rotating shaft right rod is provided with a third rotating shaft right rod fixing hole.

The first left joint mounting hole of the third rotating shaft is provided in correspondence with the third rotating shaft right rod fixing hole, the second left joint mounting hole of the third rotating shaft is provided in correspondence with the third rotating shaft left rod fixing hole.

The cylindrical plug mainly plays a positioning role, by using screws to connect the joint with the rotating shaft, the screws pass through the first left joint mounting holes of the third rotating shaft and the third rotating shaft right rod fixing holes, the screws pass through the second left joint mounting holes of the third rotating shaft and the third rotating shaft left rod fixing holes.

Further, the third rotating shaft right rod is provided with a third rotating shaft right rubber strip insertion groove, the third rotating shaft left rod is provided with a third rotating shaft left rod groove, the third rotating shaft further includes a third rotating shaft intermediate rubber strip, the third rotating shaft intermediate rubber strip includes a third rotating shaft intermediate rubber strip insertion end and a third rotating shaft intermediate rubber strip hole, the third rotating shaft intermediate rubber strip insertion end is connected to the third rotating shaft right rubber strip insertion groove, the third rotating shaft intermediate rubber strip hole can be compressed.

When the car cover is folded, the third rotating shaft hinge bottom squeezes the third rotating shaft intermediate rubber strip extrusion surface, when the car cover is spread flat, the first waterproof border of the third rotating shaft intermediate rubber strip and the first waterproof surface of the third rotating shaft left rod located on the third rotating shaft intermediate rubber strip form the first waterproofing. The second waterproof surface of the third rotating shaft left rod rubber strip and the second waterproof border of the third rotating shaft intermediate rubber strip form a second waterproofing course. The extrusion of the third rotating shaft left rod and the third rotating shaft intermediate rubber strip form a third waterproofing course.

A car cover with rotating shaft hinges, including a large front bar, a first rotating shaft, a rear bar and a guide rail, the guide rail is connected to the cargo hopper, the first rotating shaft is connected to a first rotating shaft hinge or a third rotating shaft hinge.

A car cover with rotating shaft hinges, including a large front bar, a first rotating shaft, a third rotating shaft, a rear bar and a guide rail, the guide rail is connected to the cargo hopper, either the first rotating shaft or the third rotating shaft is connected to a rotating shaft.

The rotating shaft includes an intermediate rotating shaft and two side rods, the intermediate rotating shaft is rotationally connected to the side rods, both the intermediate rotating shaft and the side rods are provided with a rotating shaft groove, a rubber strip is provided between the intermediate rotating shaft and the side rods, the rubber strip includes a waterproof surface and two mounting feet, the two mounting feet are respectively stuck into the two rotating shafts grooves, one end of the rubber strip is provided with a steel wire rod, the other end of the rubber strip is connected by glue, the steel wire rod is provided inside the rotating shaft grooves.

Two side rods are connected to a plate, the intermediate rotating shaft is rotationally connected to the two side rods, so as to achieve the relative rotation of the plates and drive the car cover to flip and fold, by setting up a rubber strip at the rotation to carry out waterproofing treatment and avoid water leakage of the car cover, one end of the rubber strip is connected to the side rods or the intermediate rotating shaft by glue, the other side of the rubber strip tightly clamps the mounting feet to the rotating shaft groove by plugging the steel wire rod to make a better waterproofing effect.

A car cover with rotating shaft hinges, includes a large front bar, a first rotating shaft, a third rotating shaft, a rear bar, and a guide rail, the guide rail is connected to the cargo hopper, at least one of the first rotating shaft, the third rotating shaft and the rear bar is connected to a rotating shaft locking bolt system, the rotating shaft locking system includes a guide rail locking bolt clamp and a rotating locking bolt.

The guide rail locking bolt clamp is connected to the guide rail, the guide rail locking bolt clamp includes a guide rail locking bolt, the guide rail locking bolt is provided with a guide rail locking bolt arc surface and a guide rail locking bolt plane, the guide rail locking bolt arc surface is located on the upper side of the guide rail locking bolt plane.

The rotating shaft locking bolt is provided in correspondence with the guide rail locking bolt, the rotating shaft locking bolt is connected to a rotating shaft or a rear bar, the rotating shaft locking bolt includes a rotating shaft locking bolt plane and a rotating shaft locking bolt circular arc surface, the rotating shaft locking bolt circular arc surface is provided on the lower side of the rotating shaft locking bolt plane.

The beneficial effect of the present invention is that the present invention enables a longer service life of the rotating shaft by adding a rotating shaft hinge as a rotation centre for flipping and folding the car cover.

### DESCRIPTION OF DRAWINGS

FIG. 1 is a structure schematic diagram I of the present invention.

FIG. 2 is a structure schematic diagram II of the present invention.

FIG. 3 is a structure schematic diagram III of the present invention.

FIG. 4 is a partially enlarged view of part A in FIG. 3.

FIG. 5 is a structure schematic diagram IV of the present invention.

FIG. 6 is a partially enlarged view of part B in FIG. 5.

FIG. 7 is a partially enlarged view of part C in FIG. 6.

FIG. 8 is a structure schematic diagram I of the first rotating shaft hinge in the present invention.

FIG. 9 is a structure schematic diagram II of the first rotating shaft hinge in the present invention.

FIG. 10 is a structure schematic diagram III of the first rotating shaft hinge in the present invention.

FIG. 11 is a structure schematic diagram IV of the first rotating shaft hinge in the present invention.

FIG. 12 is a structure schematic diagram IV of the present invention.

FIG. 13 is a structure schematic diagram I of the third rotating shaft hinge in the present invention.

FIG. 14 is a structure schematic diagram II of the third rotating shaft hinge in the present invention.

FIG. 15 is a structure schematic diagram III of the third rotating shaft hinge in the present invention.

FIG. 16 is a partially enlarged view of part D in FIG. 15.

FIG. 17 is a connection schematic diagram I of the third rotating shaft hinge in the present invention.

FIG. 18 is a connection schematic diagram II of the third rotating shaft hinge in the present invention.

FIG. 19 is a connection schematic diagram III of the third rotating shaft hinge in the present invention.

FIG. 20 is a connection schematic diagram of the second rotating shaft hinge in the present invention.

Figures: 1—Large front bar, 2—First rotating shaft, 21—Side bar, 22—Steel wire rod, 23—Rubber strip, 2301—Rubber strip lower plane, 24—Glue, 25—Intermediate rotating shaft, 2501—Intermediate rotating shaft plane, 2502—Rotating shaft groove, 3—Second rotating shaft, 4—Third rotating shaft, 41—Third rotating shaft left rod, 4101—Third rotating shaft left rod fixing holes, 4102—First waterproof surface of the third rotating shaft Left rod rubber strip, 4103—Second waterproof surface of the third rotating shaft left rod rubber strip, 4108—Third rotating shaft left rod groove, 42—Third rotating shaft right rod, 4201—Third rotating shaft right rod fixing holes, 4202—Third rotating shaft right rod groove, 4203—Third rotating shaft right rubber strip insertion groove, 4204—Rotating groove, 4205—Rotating shaft, 43—Third rotating shaft intermediate rubber strip, 4301—Third rotating shaft intermediate rubber strip hole, 4302—Third rotating shaft intermediate rubber strip extrusion surface, 4303—Third rotating shaft intermediate rubber strip insertion end, 4304—Second waterproof border of the third rotating shaft intermediate rubber strip, 4305—First waterproof border of the third rotating shaft intermediate rubber strip, 44—First left joint of the third rotating shaft, 4401—First left joint mounting hole of third rotating shaft, 45—Second left joint of the third rotating shaft, 4501—Second left joint mounting hole of third rotating shaft second left joint mounting hole, 46—Third rotating shaft hinge, 4601—Third rotating shaft hinge cylinder, 4602—Third rotating shaft hinge arm, 4603—Third rotating shaft hinge bottom, 4604—Rotating axis, 4605—Rotating claw, 47—Third rotating shaft hinge positioning block, 4701—Third rotating shaft positioning block fixing hole, 4702—Third rotating shaft fixing block mounting locating edge, 48—First right joint of third rotating shaft, 4801—Cylindrical plug, 49—Second right joint of third rotating shaft, 5—Rear rail, 51—Rotating shaft locking bolt system, 511—Rotating shaft latch, 5111—Rotating shaft locking bolt plane, 5112—Rotating shaft locking bolt arc plane, 6—Guide rail, 61—Guide rail locking bolt clamp, 611—Guide rail latch, 6111—Guide rail locking bolt arc plane, 6112—Guide rail locking bolt plane, 7101—First hinge base, 71011—Hinge connecting hole, 71012—Bottom hole, 7102—Second hinge base, 7103—First crank, 71031—Crank connecting hole, 7104—Second crank, 72—First profile, 73—Second profile.

### The Concrete Method to Carry out

The following instruction further explains the invention's concrete implementation method.

In order to enable a clearer understanding of the objects mentioned above, features and advantages of the present invention, the invention is described in detail below in connecting with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying drawings. It should be understood that the specific embodiments described herein are intended only to illustrate and explain the present invention and not to limit it.

### Embodiment 1

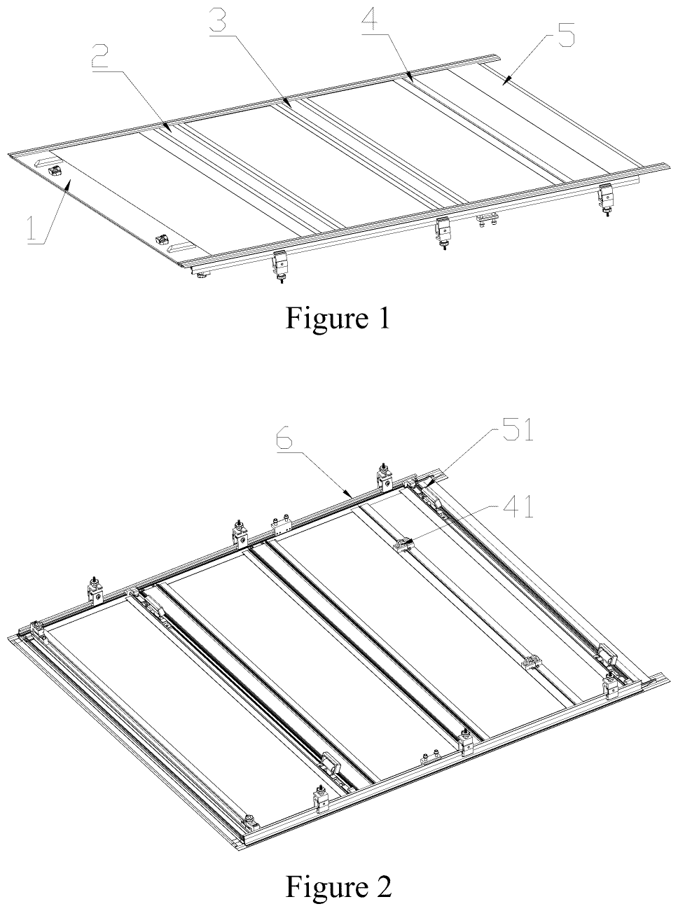

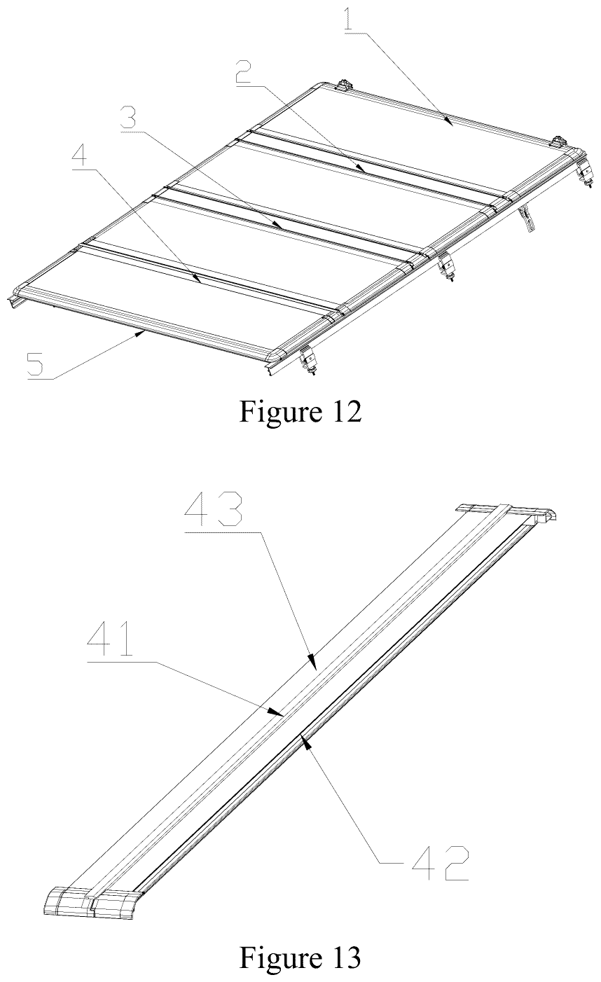

As shown in FIGS. 1 and 12, a car cover with rotating shaft hinges includes a large front bar 1, a rear bar 5, a guide rail 6 and a plurality of rotating shafts (herein the rotating shaft refers to a rotating shaft assembly, which comprises a plurality of components), the large front bar, the rotating shafts and the rear bar are connected to each other by a plate body, a plurality of the rotating shafts are provided between the large front bar 1 and the rear bar 5.

The guide rail 6 is connected to the car body, the large front bar 1, the rear bar 5 and the plurality of rotating shafts are connected to the guide rail 6, at least one of the rotating shafts is connected to a rotating shaft hinge, the rotating shafts includes a first rotating shaft 2, a second rotating shaft 3 and a third rotating shaft 4.

The car cover may include a variety of rotating shaft structures or only one, the rotating shafts are connected at the rotating shafts by a rotating shaft hinge, which enables a longer service life of the rotating shafts.

### Embodiment 2

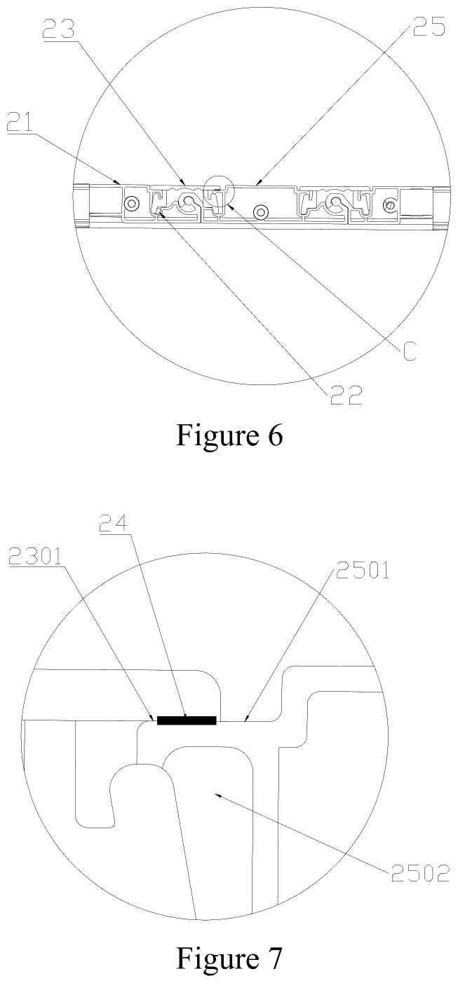

As shown in FIGS. 1, 2, 5-7, a car cover with rotating shaft hinges includes a large front bar 1, a rear bar 5, a guide rail 6 and a plurality of rotating shafts; The guide rail 6 is connected to the car body, the large front bar 1, the rear bar 5 and the plurality of rotating shafts are connected to the guide rail 6, a plurality of the rotating shafts are provided between the large front bar 1 and the rear bar 5.

The rotating shafts include an intermediate rotating shaft 25 and two side rods 21, the intermediate rotating shaft 25 is rotationally connected to the side rods 21, both the intermediate rotating shaft 25 and the side rods 21 are provided with a rotating shaft groove 2502, a rubber strip 23 is provided between the intermediate rotating shaft 25 and the side rods 21, the rubber strip 23 includes a waterproof surface and two mounting feet, both of which are connected to the waterproof surface, the two mounting feet are respectively stuck in the two rotating shaft grooves 2502, one end of the rubber strip 23 is provided with a steel wire rod 22, the other end of the rubber strip 23 is connected by glue 24, the steel wire rod 22 is provided in the rotating shaft groove 2502.

Two side rods 21 are respectively connected to a plate, an intermediate rotating shaft 25 is rotationally connected to the two side rods 21, so as to achieve the relative rotation of the plates and drive the car cover to flip and fold, by setting a rubber strip 23 at the rotation to carry out waterproofing treatment and avoid water leakage of the car cover, one end of the rubber strip 23 is connected to the side rods 21 or the intermediate rotating shaft 25 by glue 24, the other side of the rubber strip 23 is connected to the side rods 21 or the intermediate rotating shaft 25 by plugging the steel wire rod 22, which makes the mounting feet tightly clamped with the rotating shaft groove to achieve a better waterproofing effect, since it is difficult to plug the rubber strips 23 at both ends at the same time, one side is waterproofed by plugging the rubber strips 23 and the other side is waterproofed by gluing.

### Embodiment 3

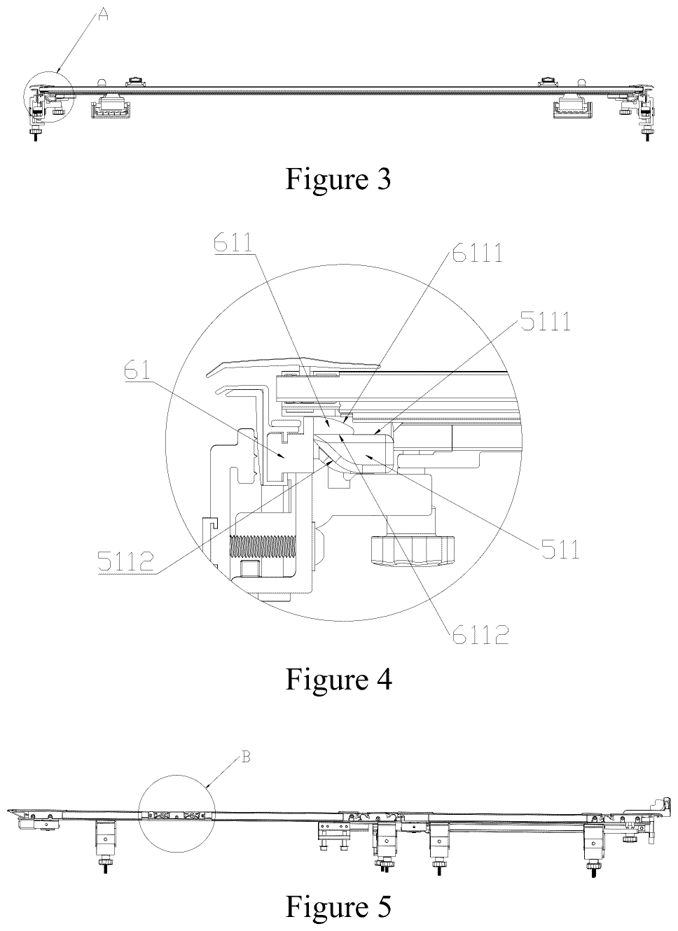

As shown in FIGS. 1-4, a car cover with rotating shaft hinges includes a large front bar 1, a rear bar 5, a guide rail 6 and a plurality of rotating shafts, the guide rail 6 is connected to the car body, the large front bar 1, the rear bar 5 and the plurality of rotating shafts are connected to the guide rail 6, a plurality of said rotating shafts are provided between the large front bar 1 and the rear bar 5.

The rotating shafts and the rear bar 5 are connected with at least one rotating shaft locking bolt system 51, the rotating shaft locking bolt system 51 includes a guide rail locking bolt clamp 61 and a rotating shaft locking bolt 511.

The guide rail locking bolt clamp 61 is connected to the guide rail 6, the guide rail locking bolt clamp 61 includes a guide rail locking bolt 611, the guide rail locking bolt 611 is provided with a guide rail locking bolt arc surface 6111 and a guide rail locking bolt plane 6112, the guide rail locking bolt arc surface 6111 is located on the upper side of the guide rail locking bolt plane 6112.

The rotating shaft locking bolt 511 is provided in correspondence with the guide rail locking bolt 611, the rotating shaft locking bolt 511 is connected to a rotating shaft or a rear bar 5, the rotating shaft locking bolt 511 includes a rotating shaft locking bolt plane 5111 and a rotating shaft locking bolt arc surface 5112, the rotating shaft locking bolt arc surface 5112 is provided on the lower side of the rotating shaft locking bolt plane 5111.

When locking, first place the rotating shaft locking bolt arc surface 5112 on the upper side of the guide rail locking bolt arc surface 6111, then press the car cover to make the rotating shaft locking bolt arc surface 5112 extruded and contracted, followed by it extends after crossing the guide rail locking bolt 611, the rotating shaft locking bolt plane 5111 is clamped with the guide rail locking bolt plane 6112 to complete the locking of the car cover.

The rotating shaft locking bolt 511 is further provided with a spring, the spring is used to drive the rotating shaft locking bolt 511 to stretch, the structure of the rotating shaft locking bolt 511 belongs to the previous technology, which is directly transferred herein.

### Embodiment 4

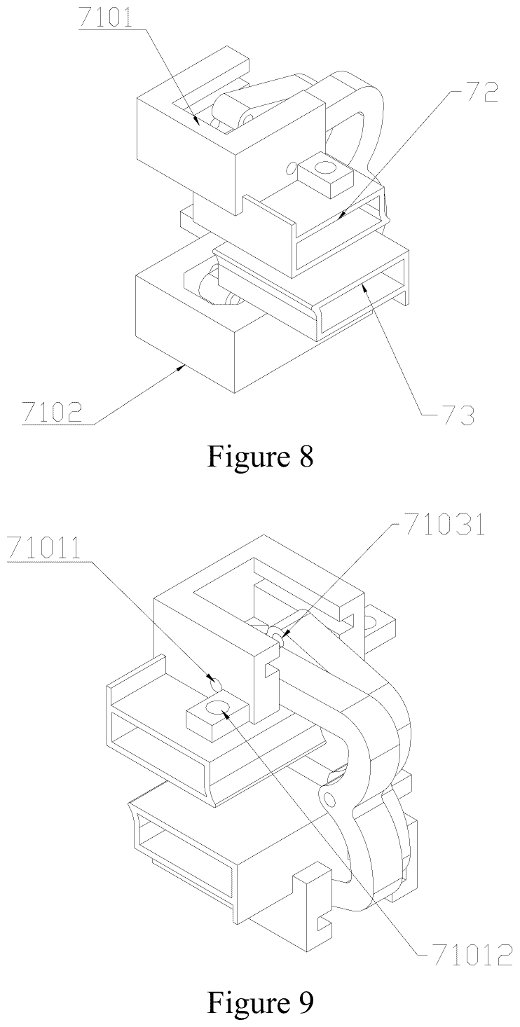

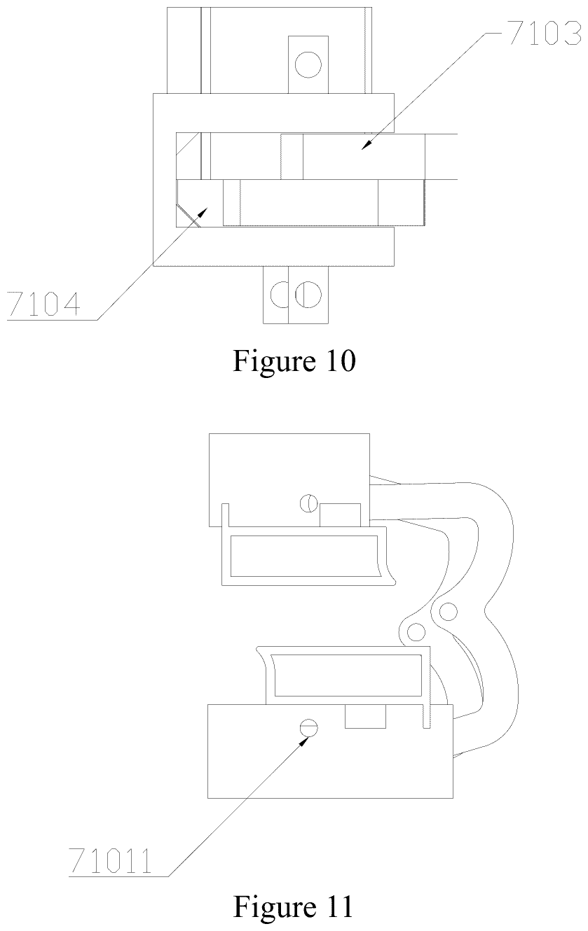

On the basis of Embodiment 1, as shown in FIGS. 8-11, the rotating shaft hinge includes a first rotating shaft hinge, the first rotating shaft hinge includes a first hinge base 7101, a second hinge base 7102, a first crank handle 7103, a second crank handle 7104, a first profile 72, and a second profile 73, both the first hinge base 7101 and the second hinge base 7102 are provided with a bottom hole 71012 and a hinge connecting hole 71011, the first hinge base 7101 is connected to the first profile 72 through the bottom hole 71012, the second hinge base 7102 is connected to the second profile 73 through the bottom hole 71012, the first profile 72 and the second profile 73 herein are car covers, both the first crank 7103 and the second crank 7104 are provided with a crank connecting hole 71031, the rotating shaft passes through the crank connecting holes 71031 and the hinge connecting holes 71011.

### Embodiment 5

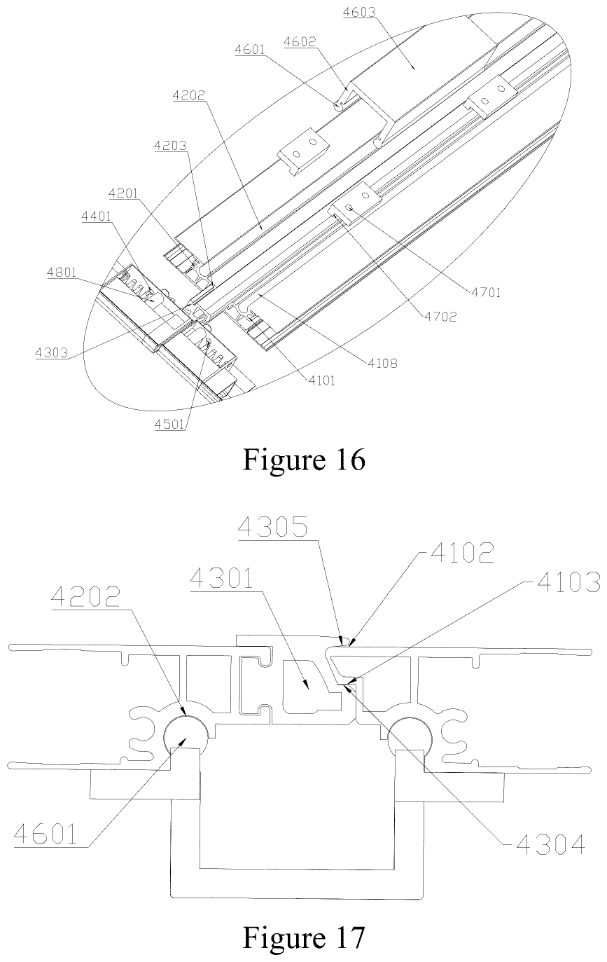

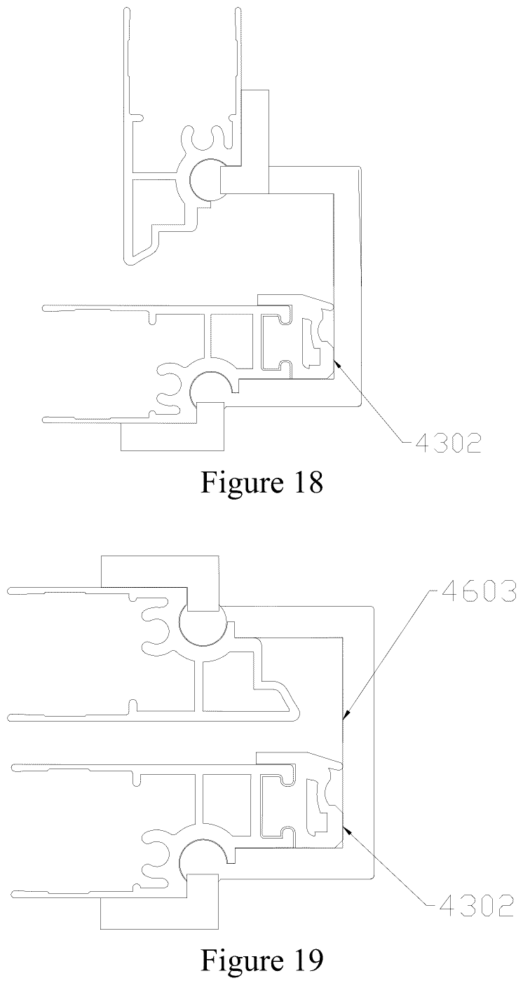

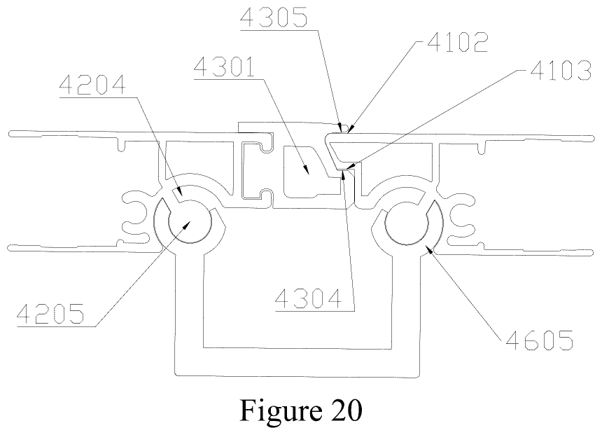

On the basis of Embodiment 1, as shown in FIGS. 13-19, the third rotating shaft 4 includes a third rotating shaft left rod 41, a third rotating shaft right rod 42, a third rotating shaft intermediate rubber strip 43, a first left joint of the third rotating shaft 44, a second left joint of the third rotating shaft 45, a third rotating shaft hinge 46, a third rotating shaft hinge positioning block 47, a first right joint of the third rotating shaft 48, and a second right joint of the third rotating shaft 49.

The first left joint of the third rotating shaft 44 and the second left joint of the third rotating shaft 45 are provided on the left side of the third rotating shaft 4, the first right joint of the third rotating shaft 48 and the second right joint of the third rotating shaft 49 are provided on the right side of the third rotating shaft 4, the third rotating shaft left rod 41 is provided with a third rotating shaft left rod groove 4108, the third rotating shaft right rod 42 is provided with a third rotating shaft right rod groove 4202, the third rotating shaft hinge 46 includes a third rotating shaft hinge bottom 4603, both ends of the third rotating shaft hinge bottom 4603 are provided with a third rotating shaft hinge arm 4602 and a third rotating shaft hinge cylinder 4601, the two third rotating shaft hinge cylinders 4601 are respectively snapped into the third rotating shaft left rod groove 4108 and the third rotating shaft right rod groove 4202.

### Embodiment 6

On the basis of embodiment 2, the rubber strip 23 is provided with a rubber strip lower plane 2301, the intermediate rotating shaft 25 is provided with an intermediate rotating shaft plane 2501, the rubber strip lower plane 2301 and the intermediate rotating shaft plane 2501 are bonded by glue 24.

### Embodiment 7

On the basis of Embodiment 5, the third rotating shaft 4 includes a plurality of third rotating shaft hinge positioning blocks 47, the third rotating shaft hinge 46 is connected to a third rotating shaft left rod 41 or the third rotating shaft right rod 42 through a plurality of third rotating shaft hinge positioning blocks 47, the third rotating shaft hinge positioning blocks 47 are provided with a third rotating shaft positioning block fixing holes 4701 and a third rotating shaft fixing block mounting positioning edges 4702, the third rotating shaft hinge positioning block 47 is connected to the third rotating shaft left rod 41 or the third rotating shaft right rod 42 through the third rotating shaft positioning block fixing hole 4701, the third rotating shaft fixing block mounting positioning edge 4702 is for mounting and positioning of the third rotating shaft hinge positioning block 47. In actual use, each third rotating shaft hinge 46 is positioned by four third rotating shaft hinge positioning blocks 47, the four third rotating shaft hinge positioning blocks 47 are provided at both ends of the third rotating shaft hinge 46.

The first left joint of the third rotating shaft 44, the second left joint of the third rotating shaft 45, the first right joint of the third rotating shaft 48 and the second right joint of the third rotating shaft 49 are all provided with a cylindrical plug 4801, the cylindrical plug 4801 is connected with either the third rotating shaft left rod groove 4108 or the third rotating shaft right rod groove 4202, when connecting, insert the cylindrical plug 4801 of the first left joint of the third rotating shaft 44 and the cylindrical plug 4801 of the first right joint of the third rotating shaft 48 into the third rotating shaft right rod groove 4202, making the first left joint of the third rotating shaft 44, the first right joint of the third rotating shaft 48 connected to the third rotating shaft right rod 42; insert the cylindrical plug 4801 of the second left joint of the third rotating shaft 45 and the cylindrical plug 49 of the third rotating shaft second right joint 49 into the third rotating shaft left rod groove 4108, making the third rotating shaft first left joint 45, the third rotating shaft second right joint 49 connected to the third rotating shaft left rod 41, so as to make the first left joint of the third rotating shaft 44, the second left joint of the third rotating shaft 45, the first right joint of the third rotating shaft 48 and the second right joint of the third rotating shaft 49 connected with the third rotating shaft left rod groove 4108 or the third rotating shaft right rod groove 4202.

The first left joint 44 of the third rotating shaft is provided with a first left joint mounting hole 4401 of the third rotating shaft, the second left joint 45 of the third rotating shaft is provided with a second left joint mounting hole 4501 of the third rotating shaft.

The third rotating shaft left rod 41 is provided with a third rotating shaft left rod fixing hole 4101, the third rotating shaft right rod 42 is provided with a third rotating shaft right rod fixing hole 4201.

The first left joint mounting hole 4401 of the third rotating shaft is provided in correspondence with the third rotating shaft right rod fixing hole 4201, the second left joint mounting hole 4501 of the third rotating shaft is provided in correspondence with the third rotating shaft left rod fixing hole 4101.

The cylindrical plug 4801 mainly plays a positioning role, by using screws to connect the joint with the rotating shaft, the screws pass through the first left joint mounting holes of the third rotating shaft 4401 and the third rotating shaft right rod fixing holes 4201, while the screws pass through the second left joint mounting holes of the third rotating shaft 4501 and the third rotating shaft left rod fixing holes 4101.

### Embodiment 8

On the basis of embodiment 7, the third rotating shaft right rod 42 is provided with a third rotating shaft right rubber strip insertion groove 4203, the third rotating shaft left rod 41 is provided with a third rotating shaft left rod groove 4108, the third rotating shaft 4 further includes a third rotating shaft intermediate rubber strip 43, the third rotating shaft intermediate rubber strip 43 includes a third rotating shaft intermediate rubber strip insertion end 4303 and a third rotating shaft intermediate rubber strip hole 4301, the third rotating shaft intermediate rubber strip insertion end 4303 is connected to the third rotating shaft right rubber strip insertion groove 4203, the third rotating shaft intermediate rubber strip hole 4301 can be compressed.

When the car cover is folded, the third rotating shaft hinge bottom 4603 squeezes the third rotating shaft intermediate rubber strip extrusion surface 4302, when the car cover is spread flat, the first weatherproof border of third rotating shaft intermediate rubber strip 4305 on the third rotating shaft intermediate rubber strip 43 and a first waterproof surface of the third rotating shaft left rod rubber strip 4102 on the third rotating shaft left rod 41 form the first waterproofing. The second waterproof surface of the third rotating shaft left rod rubber strip 4103 and the second waterproof border of the third rotating shaft intermediate rubber strip 4304 form a second waterproofing course. The extrusion of the third rotating shaft left rod 41 and the third rotating shaft intermediate rubber strip 43 form a third waterproofing course.

### Embodiment 9

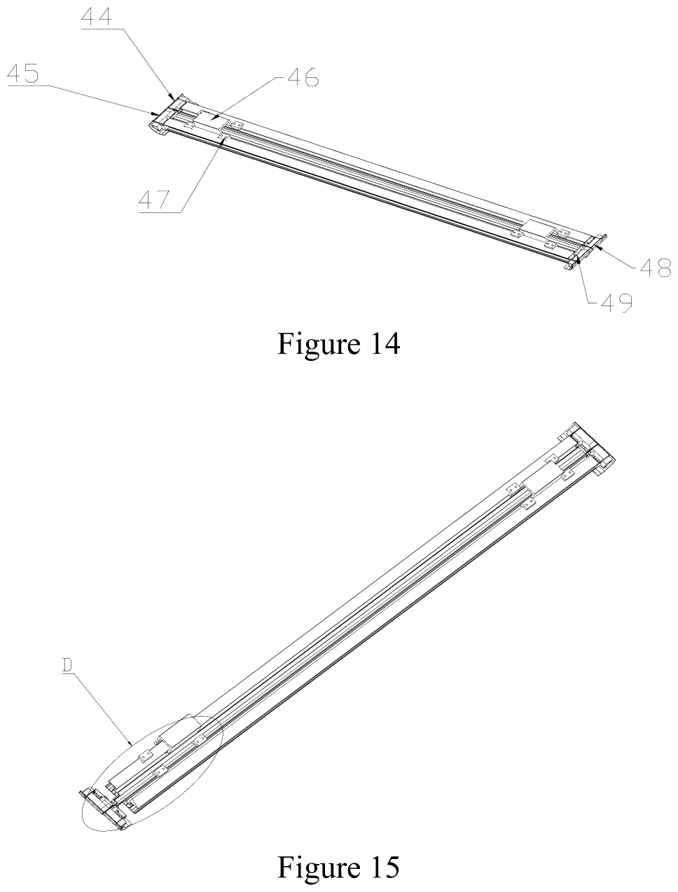

As shown in FIGS. 1 and 14, a car cover with rotating shaft hinges includes a large front bar 1, a first rotating shaft 2, a rear bar 5 and a guide rail 6, the guide rail 6 is connected to a cargo hopper, the first rotating shaft 2 is connected to a first rotating shaft hinge or a third rotating shaft hinge 46, the first rotating shaft 2 is respectively connected to the large front bar 1 and to the rear bar 5 by a plate.

### Embodiment 10

As shown in FIGS. 1, 6 and 7, a car cover with rotating shaft hinges, includes a large front bar 1, a first rotating shaft 2, a third rotating shaft 4, a rear bar 5 and a guide rail 6, the guide rail 6 is connected to a cargo hopper, either the first rotating shaft 2 or the third rotating shaft 4 is connected to a rotating shaft, the first rotating shaft 2 is connected to the large front bar 1 by a plate, the first rotating shaft 2 is connected to the third rotating shaft 4 by a plate, the third rotating shaft 4 is connected is connected to the rear bar 5 by a plate.

The rotating shaft includes an intermediate rotating shaft 25 and two side bars 21, the intermediate rotating shaft 25 is rotationally connected to the side bars 21, both the intermediate rotating shaft 25 and the side bars 21 are provided with a rotating shaft groove 2502, a rubber strip 23 is provided between the intermediate rotating bar and the side bars 21, the rubber strip 23 includes a waterproof surface and two mounting feet, the two mounting feet are respectively stuck into the two rotating shaft grooves 2502, one end of the rubber strip 23 is provided with a steel wire rod 22, the other end of the rubber strip 23 is connected by glue 24, the steel wire rod 22 is provided inside the rotating shaft groove 2502.

Two side rods 21 are connected to a plate respectively, the intermediate rotating shaft 25 is rotationally connected to the two side rods 21 to achieve the relative rotation of the plates and drive the car cover to flip and fold, by setting a rubber strip 23 at the rotation place to carry out waterproofing treatment and avoid water leakage of the car cover, one end of the rubber strip 23 is connected to the side rods 21 or the intermediate rotating shaft 25 through glue 24, the other side of the rubber strip 23 tightly clamps the mounting foot to the rotating shaft groove 2502 by plugging the steel wire rod 22 to make a better waterproofing effect.

### Embodiment 11

As shown in FIGS. 1-4, a car cover with rotating shaft hinges, including a large front bar 1, a first rotating shaft 2, a third rotating shaft 4, a rear bar 5 and a guide rail 6, the guide rail 6 is connected to the cargo hopper, at least one of the first rotating shaft 2, the third rotating shaft 4 and the rear bar 5 is connected to a rotating locking bolt system 51, the rotating locking system includes a guide rail locking bolt clamp 61 and a rotating locking bolt 511, the first rotating shaft 2 is connected with the large front bar 1 by a plate, the first rotating shaft 2 is connected to the third rotating shaft 4 by a plate, the third rotating shaft 4 is connected to the rear bar 5 by a plate.

The guide rail locking bolt clamp 61 is connected to the guide rail 6, the guide rail locking bolt clamp 61 includes a guide rail locking bolt 611, the guide rail locking bolt 611 is provided with a guide rail locking bolt arc surface 6111 and a guide rail locking bolt plane 6112, the guide rail locking bolt arc surface 6111 is located on the upper side of the guide rail locking bolt plane 6112.

The rotating shaft locking bolt 511 is provided in correspondence with the guide rail locking bolt 611, the rotating shaft locking bolt 511 is connected to the rotating shaft or the back bar 5, the rotating shaft locking bolt 511 includes a rotating shaft locking bolt plane 5111 and a rotating shaft locking bolt arc surface 5112, the rotating shaft locking bolt arc surface 5112 is provided on the lower side of the rotating shaft locking bolt plane 5111.

### Embodiment 12

As shown in FIGS. 13 and 14, a car cover with rotating shaft hinges includes a front bar 1, a first rotating shaft 2, a second rotating shaft 3, and a rear bar 5, the first rotating shaft 2 is connected to the large front bar 1 by a plate, the first rotating shaft 2 is connected to the second rotating shaft 3 by a plate, the second rotating shaft 3 is connected to the rear bar 5 by a plate, at least one of the first rotating shaft 2 and the second rotating shaft 5 is connected to either a first rotating shaft hinge or third rotating shaft hinge 46, at least one of the first rotating shaft 2 and the second rotating shaft 5 is connected with a waterproof rubber strip 43, the waterproof rubber strip 43 is provided in correspondence with the first rotating shaft hinge or the third rotating shaft hinge 46.

### Embodiment 13

As shown in FIGS. 13 and 14, a car cover with rotating shaft hinges, includes a large front bar 1, a first rotating shaft 2, and a rear bar 5, a plurality of said rotating shafts are provided between the large front bar 1 and the rear bar 5, the first rotating shaft 2 is connected to the large front bar 1 by a plate, the first rotating shaft 2 is connected to the rear bar 5 by a plate, the first rotating shaft 2 is provided with the first rotating shaft hinge or the third rotating shaft hinge 46, the first rotating shaft 2 is provided with a waterproof rubber strip 43.

### Embodiment 14

As shown in FIGS. 1 and 20, a car cover with rotating shaft hinges includes a large front bar 1, a rear bar 5, a guide rail 6 and a plurality of rotating shafts.

The guide rail 6 is connected to the car body, the large front bar 1, the rear bar 5 and the plurality of rotating shafts are connected to the guide rail 6, at least one of the rotating shafts is connected to a second rotating shaft hinge, the rotating shafts includes a first rotating shaft 2, a second rotating shaft 3 and a third rotating shaft 4, the first rotating shaft 2 is connected to the large front bar 1 by a plate, the first rotating shaft 2 is connected to the second rotating shaft 3 by a plate, the second rotating shaft 3 is connected to the third rotating shaft 4 by a plate, the third rotating shaft 4 is connected to the rear bar by a plate.

The third rotating shaft 4 includes a third rotating shaft left rod 41, a third rotating shaft right rod 42, a third rotating shaft intermediate rubber strip 43, a first left joint of the third rotating shaft 44, a second left joint of the third rotating shaft 45, a first right joint of the third rotating shaft 48 and a second right joint of the third rotating shaft 49.

The first left joint of the third rotating shaft 44 and the second left joint of the third rotating shaft 45 are provided on the left side of the third rotating shaft 4, the first right joint of the third rotating shaft 48 and the second right joint of the third rotating shaft 49 are provided on the right side of the third rotating shaft 4, both the third rotating shaft right rod 42 and the third rotating shaft left rod 41 are provided with rotation grooves 4204, the central part of the rotation grooves 4204 is provided with a rotating shaft 4205, the second rotating shaft hinge includes a second rotating shaft hinge bottom, both ends of the second rotating shaft hinge bottom are provided with rotating jaws 4605, the two rotating jaws 4605 are respectively seated with the rotating groove 4204 and rotated along the rotating groove 4204.

The rotating jaw 4605 extends into the rotating groove 4204 and is coaxially connected with the rotating shaft 4205 in rotation, a third rotating shaft hinge positioning block 47 can also be connected at both ends of the second rotating shaft hinge to realise the positioning of the second rotating shaft hinge.

### Embodiment 15

As shown in FIGS. 1, 2, 5-7, a car cover with rotating shaft hinges includes a large front bar 1, a rear bar 5, a guide rail 6 and a plurality of rotating shafts, the plurality of rotating shafts are provided between the large front bar 1 and the rear bar 5.

The guide rail 6 is connected to the car body, the large front bar 1, the rear bar 5 and the plurality of rotating shafts are all connected to the guide rail 6.

The rotating shaft includes an intermediate shaft 25 and two side bars 21, the intermediate shaft 25 is rotationally connected to the side bars 21, a rubber strip 23 is provided between the intermediate shaft 25 and the side bars 21, the rubber strip 23 is bonded to the fronts of the intermediate shaft 25 and the side bars 21 by glue 24.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A car cover with rotating shaft hinges, wherein, it includes a large front bar (1), a rear bar (5), a guide rail (6) and a plurality of rotating shafts, the plurality of rotating shafts are provided between the large front bar (1) and the rear bar (5).
The guide rail (6) is connected to the car body, the large front bar (1), the rear bar (5) and the plurality of rotating shafts are connected to the guide rail (6), at least one of the rotating shafts is connected with a rotating shaft hinge, the rotating shaft includes a first rotating shaft (2), a second rotating shaft (3) and a third rotating shaft (4).

2. A car cover with rotating shaft hinges, wherein, it includes a large front bar (1), a rear bar (5), a guide rail (6) and a plurality of rotating shafts, the plurality of rotating shafts are provided between the large front bar (1) and the rear bar (5).
The guide rail (6) is connected to the car body, the large front bar (1), the rear bar (5) and the plurality of rotating shafts are all connected to the guide rail (6).
The rotating shafts includes an intermediate rotating shaft (25) and two side rods (21), the intermediate rotating shaft (25) is rotatably connected to the side rods (21), both the intermediate rotating shaft (25) and the side rods (21) are provided with a rotating shaft groove (2502), a rubber strip (23) is connected between the intermediate rotating shaft (25) and the side rods (21), the rubber strip (23) includes a waterproof surface and two mounting feet, both of which are connected to the waterproof surface, the two mounting feet are respectively stuck into the two rotating shaft grooves (2502), one end of the rubber strip (23) is provided with a steel wire rod (22), the other end of the rubber strip (23) is connected by glue (24), the steel wire rod (22) is provided inside the rotating shaft groove (2502).

3. A car cover with rotating shaft hinges, wherein, it includes a large front bar (1), a rear bar (5), a guide rail (6) and a plurality of rotating shafts, the plurality of rotating shafts are provided between the large front bar (1) and the rear bar (5).
The guide rail (6) is connected to the car body, the large front bar (1), the rear bar (5) and the rotating shafts are all connected to the guide rail (6).
The rotating shaft includes an intermediate shaft (25) and two side rods (21), the intermediate shaft (25) is rotatingly connected to the side rods (21), a rubber strip (23) is provided between the intermediate shaft (25) and the side rods (21), the rubber strip (23) is bonded to the fronts of the intermediate shaft (25) and the side rods (21) by glue (24).

4. A car cover with rotating shaft hinges, wherein, it includes a large front bar (1), a rear bar (5), a guide rail (6) and a plurality of rotating shafts, the guide rail (6) is connected to the car body, the large front bar (1), the rear bar (5) and the plurality of rotating shafts are all connected to the guide rail (6), a plurality of rotating shafts are provided between the large front bar (1) and the rear bar (5).
The rotating shafts and rear bar (5) are connected with at least one rotating shaft locking bolt system (51), the rotating shaft locking bolt system (51) includes a guide rail locking bolt clamp (61) and a rotating shaft locking bolt (511).
The guide rail locking bolt clamp (61) is connected to the guide rail (6), the guide rail locking bolt clamp (61) includes a guide rail locking bolt (611), the guide rail locking bolt (611) is provided with a guide rail locking bolt arc surface (6111) and a guide rail locking bolt plane (6112), the guide rail locking bolt arc surface (6111) is located on the upper side of the guide rail locking bolt plane (6112).
The rotating shaft locking bolt (511) is provided in correspondence with the guide rail locking bolt (611), the rotating shaft locking bolt (511) is connected to a rotating shaft or a rear bar (5), the rotating shaft locking bolt (511) includes a rotating shaft locking bolt plane (5111) and a rotating shaft locking bolt arc surface (5112), the rotating shaft locking bolt arc surface (5112) is provided on the lower side of the rotating shaft locking bolt plane (5111).

5. A car cover with rotating shaft hinges according to claim 1, wherein, the rotating shaft hinge includes a first rotating shaft hinge, the first rotating shaft hinge includes a first hinge base (7101), a second hinge base (7102), a first crank handle (7103), a second crank handle (7104), a first profile (72), and a second profile (73), both the first hinge base (7101) and second hinge base (7102) are provided with a bottom hole (71012) and a hinge connecting hole (71011), the first hinge base (7101) is connected to the first profile (72) through the bottom hole (71012), the second hinge base (71012) is connected to the second profile (73) through the bottom hole (71012), both the first crank handle (7103) and second crank (7104) are provided with a crank connecting hole (71031), the rotating shaft passes through the crank connecting holes (71031) and the hinge connecting holes (71011).

6. A car cover with rotating shaft hinges according to claim 1, wherein, the third rotating shaft (4) includes a first left joint (44) of the third rotating shaft, a second left joint (45) of the third rotating shaft, a first right joint (48) of the third rotating shaft, a second right joint (49) of the third rotating shaft, and a third rotating shaft hinge (46).
The first left joint (44) of third rotating shaft and the second left joint (45) of third rotating shaft are provided on the left side of the third rotating shaft (4), the first right joint (48) of third rotating shaft and the second right joint (49) of third rotating shaft are provided on the right side of the third rotating shaft (4).

7. A car cover with rotating shaft hinges according to claim 6, wherein, the third rotating shaft (4) further includes a third rotating shaft left rod (41), a third rotating shaft right rod (42) and a third rotating shaft hinge (46).
The third rotating shaft left rod (41) of is provided with a third rotating shaft left rod groove (4108).
The third rotating shaft right rod (42) is provided with a third rotating shaft right rod groove (4202).
The third rotating shaft hinge (46) includes a third rotating shaft hinge bottom (4603), both ends of the third rotating shaft hinge bottom (4603) are provided with a third rotating shaft hinge arm (4602) and a third rotating shaft hinge cylinder (4601), the two third rotating shaft hinge cylinders (4601) are respectively snapped into the third rotating shaft left rod groove (4108) and the third rotating shaft right rod groove (4202).

8. A car cover with rotating shaft hinges according to claim 2, wherein, the rubber strip (23) is provided with a rubber strip lower plane (2301), the intermediate rotating shaft (25) is provided with an intermediate rotating shaft plane (2501), the rubber strip lower plane (2301) and the intermediate rotating shaft plane (2501) are bonded by glue (24).

9. A car cover with rotating shaft hinges according to claim 8, wherein, the third rotating shaft (4) includes a plurality of third rotating shaft hinge positioning blocks (47), the third rotating shaft hinge positioning block (47) is provided with a third rotating shaft positioning block fixing hole (4701) and a third rotating shaft fixing block mounting and positioning edge (4702), the third rotating shaft hinge positioning block (47) is connected to the third rotating shaft left rod (41) or the third rotating shaft right rod (42) through the third rotating shaft positioning block fixing hole (4701), the third rotating shaft fixing block mounting and positioning edges (4702) is for mounting and positioning the third rotating shaft hinge positioning block.

10. A car cover with rotating shaft hinges according to claim 9, wherein, the first left joint of the third rotating shaft (44), the second left joint of the third rotating shaft (45), the first right joint of the third rotating shaft (48) and the second right joint of the third rotating shaft (49) are all provided with a cylindrical plug (4801), the cylindrical plug (4801) is connected with either the third rotating shaft left rod groove (4108) or the third rotating shaft right rod groove (4202).
The first left joint of the third rotating shaft (44) is provided with a first left joint mounting hole of the third rotating shaft (4401), the second left joint of the third rotating shaft (45) is provided with a second left joint mounting hole of the third rotating shaft (4501).
The third rotating shaft left rod (41) is provided with a third rotating shaft left rod fixing hole (4101), the third rotating shaft right rod (42) is provided with a third rotating shaft right rod fixing hole (4201).
The first left joint mounting hole of the third rotating shaft (4401) is provided in correspondence with the third rotating shaft right rod fixing hole (4201), the second left joint mounting hole of the third rotating shaft (4501) is provided in correspondence with the third rotating shaft left rod fixing hole (4101).

11. A car cover with rotating shaft hinges according to claim 10, wherein, the third rotating shaft right rod (42) is provided with a third rotating shaft right rubber strip insertion groove (4203), the third rotating shaft left rod (41) is provided with a third rotating shaft left rod groove (4108), the third rotating shaft (4) further includes a third rotating shaft intermediate rubber strip (43), the third rotating shaft intermediate rubber strip (43) includes a third rotating shaft intermediate rubber strip insertion end (4303) and a third rotating shaft intermediate rubber strip hole (4301), the third rotating shaft intermediate rubber strip insertion end (4303) is connected to the third rotating shaft right rubber strip insertion groove (4203).

12. A car cover with rotating shaft hinges, wherein, it includes a large front bar (1), a first rotating shaft (2), a rear bar (5) and a guide rail (6), the guide rail (6) is connected to the cargo hopper, the first rotating shaft (2) is connected to a first rotating shaft hinge or a third rotating shaft hinge (46).

13. A car cover with rotating shaft hinges, wherein, it includes a large front bar (1), a first rotating shaft (2), and a rear bar (5), the first rotating shaft (2) is connected to a first rotating shaft hinge or a third rotating shaft hinge (46), the first rotating shaft (2) is connected to a waterproof rubber strip (43).

14. A car cover with rotating shaft hinges, wherein, it includes a large front bar (1), a first rotating shaft (2), a third rotating shaft (4), a rear bar (5) and a guide rail (6), the guide rail (6) is connected to the cargo hopper, either the first rotating shaft (2) or the third rotating shaft (4) is connected to a rotating shaft.
The rotating shaft includes an intermediate rotating shaft (25) and two side rods (21), the intermediate rotating shaft (25) is rotationally connected to the side rods (21), both the intermediate rotating shaft (25) and the side rods (21) are provided with a rotating shaft groove (2502), a rubber strip (23) is provided between the intermediate rotating shaft and the side rods (21), the rubber strip (23) includes a waterproof surface and two mounting feet, which are respectively stuck into the two rotating shaft grooves (2502), one end of the rubber strip (23) is provided with a steel wire rod (22), the other end of the rubber strip (23) is connected by glue (24), the steel wire rod (22) is provided inside the rotating shaft groove (2502).

15. A car cover with rotating shaft hinges, wherein, it includes a front bar (1), a first rotating shaft (2), a second rotating shaft (3) and a rear bar (5), at least one of the first rotating shaft (2) and the second rotating shaft (5) is connected with a first rotating shaft hinge or a third rotating shaft hinge (46), at least one of the first rotating shaft (2) and the second rotating shaft (5) is connected with waterproof rubber strips (43), the waterproof rubber strips (43) are provided in correspondence with the first rotating shaft hinge or the third rotating shaft hinge (46).

16. A car cover with rotating shaft hinges, wherein, it includes a large front bar (1), a first rotating shaft (2), a third rotating shaft (4), a rear bar (5) and a guide rail (6), the guide rail (6) is connected to the cargo hopper, at least one of the first rotating shaft (2), the third rotating shaft (4) and the rear bar (5) is connected to a rotating shaft locking bolt system (51), the rotating shaft locking system includes a guide rail locking bolt clamp (61) and a rotating shaft locking bolt (511).
The guide rail locking bolt clamp (61) is connected to the guide rail (6), the guide rail locking bolt clamp (61) includes a guide rail locking bolt (611), the guide rail locking bolt (611) is provided with a guide rail locking bolt arc surface (6111) and a guide rail locking bolt plane (6112), the guide rail locking bolt arc surface (6111) is located on the upper side of the guide rail locking bolt plane (6112).
The rotating shaft locking bolt (511) is provided in correspondence with the guide rail locking bolt (611), the rotating shaft locking bolt (511) is connected to a rotating shaft or a rear bar (5), the rotating shaft locking bolt (511) includes a rotating shaft locking bolt plane (5111) and a rotating shaft locking bolt arc surface (5112), the rotating shaft locking bolt arc surface (5112) is provided on the lower side of the rotating shaft locking bolt plane (5111).

17. A car cover with rotating shaft hinges, wherein, it includes a large front bar (1), a rear bar (5), a guide rail (6) and a plurality of rotating shafts.
The guide rail (6) is connected to the car body, the large front bar (1), the rear bar (5) and the rotating shafts are connected to the guide rail (6), at least one of the rotating shafts is connected to the second rotating shaft hinge, the rotating shafts includes a first rotating shaft (2) and a third rotating shaft (4).
The third rotating shaft (4) includes a third rotating shaft left rod (41), a third rotating shaft right rod (42), a third rotating shaft intermediate rubber strip (43), a first left joint of the third rotating shaft (44), a second left joint of the third rotating shaft (45), a first right joint of the third rotating shaft (48) and a second right joint of the third rotating shaft (49).
The first left joint of the third rotating shaft (44) and the second left joint of the third rotating shaft (45) are provided on the left side of the third rotating shaft (4), the first right joint of the third rotating shaft (48) and the second right joint of the third rotating shaft (49) are provided on the right side of the third rotating shaft (4), the third rotating shaft right rod (42) and the third rotating shaft left rod (41) are provided with rotating grooves (4204), the central part of the rotating groove (4204) is provided with a rotating shaft (4205), the second rotating shaft hinge is provided with a second rotating shaft bottom, both ends of the second rotating shaft hinge bottom are provided with rotating jaws (4605), the two rotating jaws (4605) are respectively seated with the rotating groove (4204) and rotate along the rotating groove (4204).

18. A car cover with rotating shaft hinges according to claim 1, wherein, the rotating shaft hinges are of an integral elongate structure or a plurality of block structures.
